(19) United States
(12) Patent Application Publication
(10) Pub. No.: US 2024/0129625 A1
(43) Pub. Date: Apr. 18, 2024

(54) SYSTEMS AND METHODS FOR MONITORING AND CONTROL OF MULTIPLE REMOTE CAMERAS

(71) Applicant: John Battle, Clearwater, FL (US)

(72) Inventor: John Battle, Clearwater, FL (US)

(21) Appl. No.: 18/488,983

(22) Filed: Oct. 17, 2023

Related U.S. Application Data
(60) Provisional application No. 63/416,684, filed on Oct. 17, 2022.
(60) Provisional application No. 63/416,769, filed on Oct. 17, 2022.

(51) Int. Cl. H04N 23/66; H04N 23/62; H04N 23/667

(52) U.S. Cl. CPC H04N 23/66; H04N 23/62; H04N 23/667

(57) ABSTRACT

Computer-implemented methods, systems, and computer-readable media for monitoring and control of multiple remote cameras are described.

### RELATED APPLICATIONS

This application claims the benefit of U.S. Application No. 63/416,684, entitled “Device and System for the Simultaneous Remote Control of Multiple Cameras,” filed on Oct. 17, 2022, and U.S. Application No. 63/416,769, entitled “Device and System for Monitoring Control of Multiple Remote Cameras,” filed on Oct. 17, 2022, each of which is incorporated herein by reference in its entirety.

### FIELD

Some implementations are generally related to electronic cameras, and, in particular, to systems and methods for monitoring and control of multiple remote cameras.

### BACKGROUND

In planning, construction, or maintenance of relatively large-scale projects (e.g., for roads, bridges, buildings, or the like), documentation of a project before work begins, during work, or after work is allegedly completed can be important. A need may exist to document such projects using video (or still) images obtained by a system that is configured to control and monitor a system including one or more cameras, where location information and camera image frame information are aligned such that each camera frame includes metadata corresponding to the actual or interpolated location that the frame was captured and information about the orientation of the cameras system and other information such as distance and/or flags.

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

Some implementations can include a system comprising one or more camera modules, one or more camera control modules, each corresponding to one of the one or more camera modules, wherein each camera control module is configured to actuate a corresponding one of the one or more cameras and monitor a status of that camera, and a user console including a camera shutter release control and a camera status indicator. The system can also include a central control hub coupled to the user console and the one or more camera control modules, the central control hub configured to: receive an electronic shutter control signal from the camera shutter release and physically activate or deactivate the one or more cameras, via the corresponding one or more camera control modules; receive a physical status signal from each of the one or more cameras via the corresponding one or more camera control modules; transmit an electronic indicator signal based on the physical status signal to the user console to cause the camera status indicator to represent a state of each of the one or more cameras as recording or not recording. The system can also include a power supply circuit configured to supply power to the one or more cameras, the one or more camera control modules, the user console, and the central control hub. In some implementations, when activated, the one or more cameras capture image data, and when deactivated the one or more cameras stop capturing image data.

### BRIEF DESCRIPTION OF THE DRAWINGS

FIG. 1 is a block diagram showing major components of an example camera remote control and monitoring device and system in accordance with some implementations.

FIG. 2 is a frontal view of an example camera control module of the camera control and module installed on a camera in accordance with some implementations.

FIG. 3 is a frontal view of an example camera installed on a mounting device in accordance with some implementations.

FIG. 4 is rear view of an example camera control module of the camera remote control and monitoring system installed on a camera in accordance with some implementations.

FIG. 5 is a rear view of an example camera installed on a mounting device in accordance with some implementations.

FIG. 6 includes several views of an example outer shell of the camera control module in removable panel in accordance with some implementations.

FIG. 7 is a frontal view of an example open end of a camera control module in accordance with some implementations.

FIG. 8 is a rear view of example camera control module components without the outer shell in accordance with some implementations.

FIG. 9 is a frontal view of example camera control module components without the outer shell in accordance with some implementations.

FIG. 10 is a frontal view of example camera control module components mounted on a camera in accordance with some implementations.

FIG. 11 is a rear view of an example shutter mechanism and servo in relation to the camera in accordance with some implementations.

FIG. 12 is a view of an example circular cam which can be used as an alternative to the servo arm in accordance with some implementations.

FIG. 13 is a view of an example shutter release mechanism and servo with the linear actuator arm and servo arm in their first positions in accordance with some implementations.

FIG. 14 is a view of an example shutter release mechanism and servo with the linear actuator arm and servo arm in their second positions in accordance with some implementations.

FIG. 15 is a combined block diagram and electronic schematic showing example major components of the camera remote control and monitoring system in accordance with some implementations.

FIG. 16A is a combined block diagram and electronic schematic showing example major components of an alternative embodiment of the camera remote control and monitoring system wherein the servos receive control signals from a single service control circuit located in the central hub in accordance with some implementations.

FIG. 16B is a combined block diagram and electronic schematic showing example major components of the central servo control circuit in accordance with some implementations.

FIG. 17 is a combined block diagram and electronic schematic showing example major components of an alternative embodiment of the remote control and monitoring system including a command-and-control microcontroller in the console and a system management microcontroller in the central hub in accordance with some implementations.

FIG. 18 is a combined block diagram and electronic schematic showing example major components of an alternative embodiment of the remote control and monitoring system including a command-and-control microcontroller in the control console and a system management microcontroller in the central hub together with a central servo control circuit in accordance with some implementations.

FIG. 19 is a frontal view of example camera control module components mounted on a camera including the frame-marker device in accordance with some implementations.

FIG. 20 is a flowchart depicting example processes executed by firmware in the system management microcomputer in accordance with some implementations.

FIG. 21 is a schematic view of an example image from a frame of video showing a binary image pattern across sub zones of the image in accordance with some implementations.

FIG. 22A is a flowchart depicting example post processing methods to create a video specific time indexed metadata file for each video in a group of synchronized video files in accordance with some implementations.

FIG. 22B is a flowchart depicting an example alternative post processing method to create a video specific time indexed metadata file for each video in a group of synchronized video files in accordance with some implementations.

FIG. 23 is a flowchart depicting an example post processing method to create a frame-indexed metadata file for each video in a group of synchronized video files in accordance with some implementations.

FIG. 24 is a diagram of an example computing device configured for monitoring and control of multiple remote cameras in accordance with some implementations.

### DETAILED DESCRIPTION

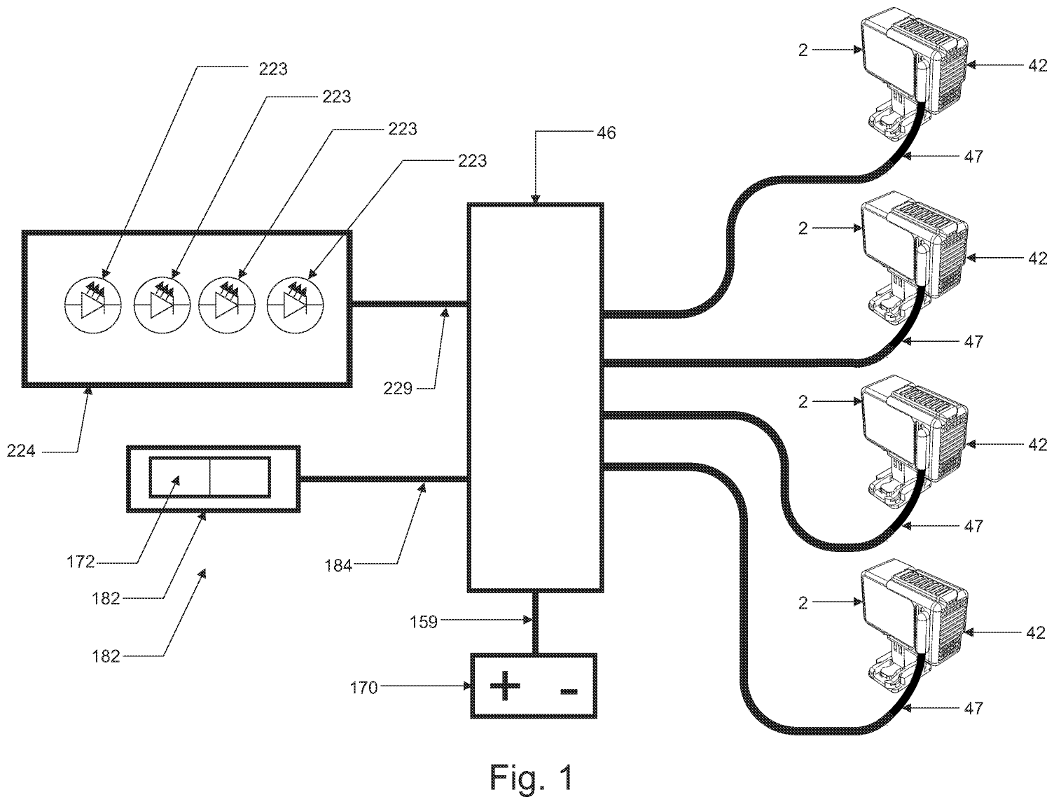

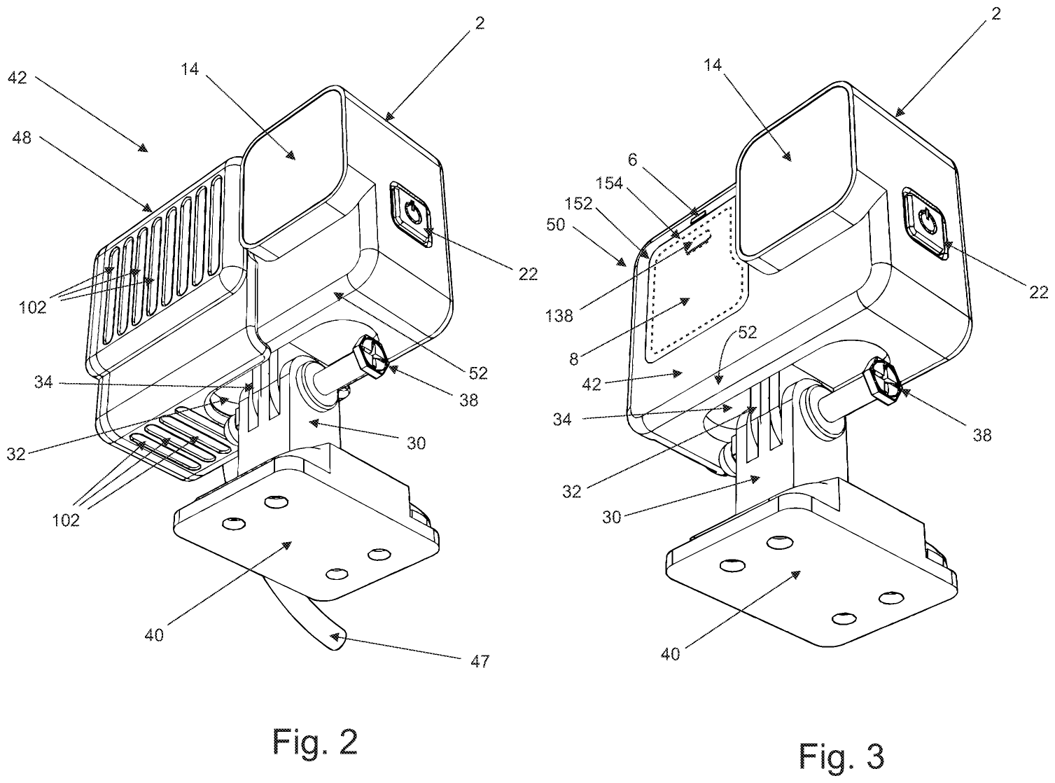

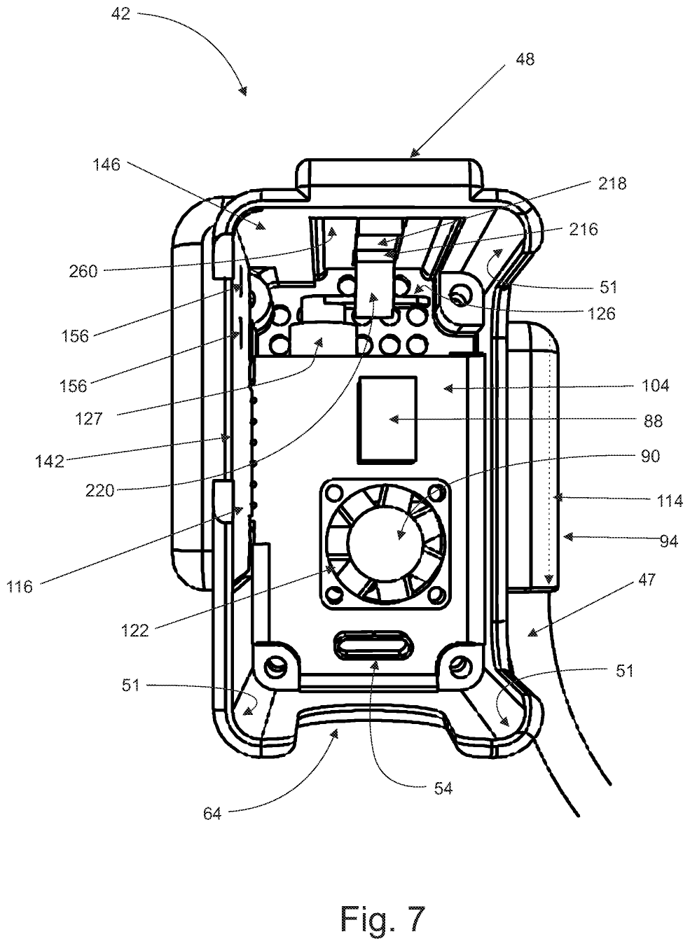

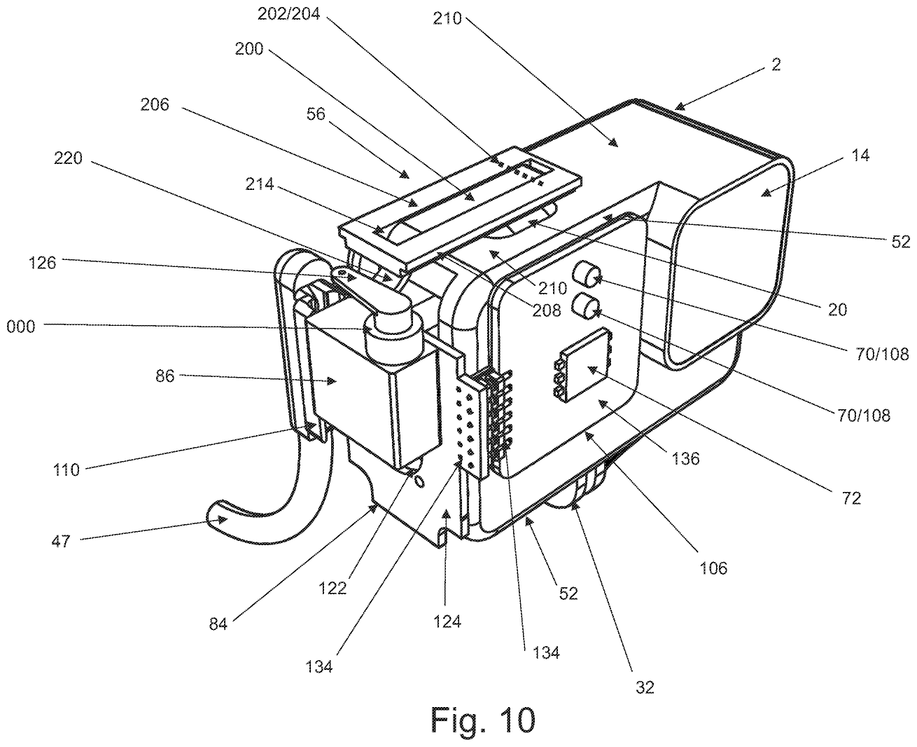

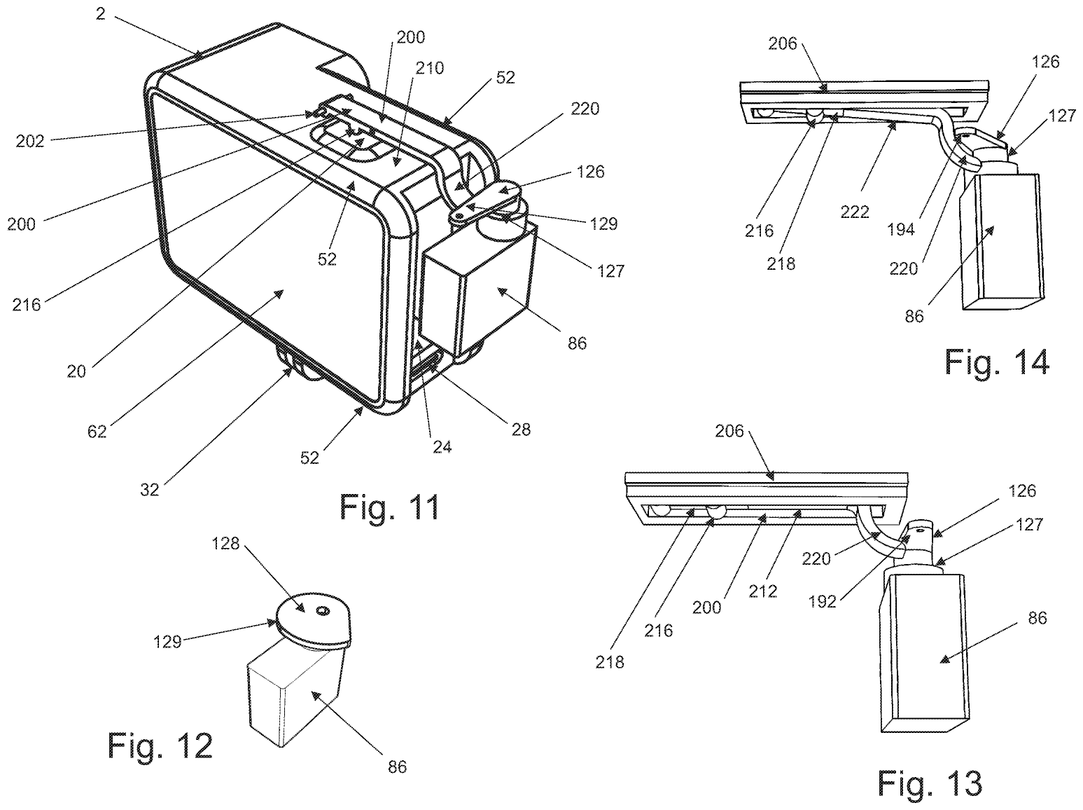

As best understood with reference to FIGS. 1-14, some implementations of the present disclosure can include a camera control system 1 for the simultaneous (or near simultaneous) shutter release and monitoring of one or more cameras 2. By mechanical manipulation of each camera shutter button 4 and optical monitoring of indicator lights 6 and or a front display screen 8 formed on the surface 10 of the camera 2. The camera control system 1 is applicable to a wide range of camera models and styles. For example, for the purposes of this description the GoPro Hero 9 action camera 2 will be described as a non-limiting example. As shown in the in the various drawings, the GoPro Hero 9 action camera 2 includes typical features found on most handheld cameras including a camera body 12 with a lens 14, front display screen 16, a rear display and control screen 18, a shutter button 20, a power on/off button 22, a battery compartment 24, a memory card slot 26, USB power and data port 28, and a mounting system 30. The mounting system 30 includes foldable brackets 32 formed on the bottom surface 34 of the camera 2 received by a detachable mounting bracket 36 affixed to the camera 2 by a bolt 38 disposed within cooperating holes formed in foldable bracket 32 of the camera 2 and matching leaves in the mounting bracket 32 such that the camera 2 may be rotated upward and downward around the axle formed by the bolt 38. As will be appreciated by those skilled in the art, the GoPro Hero series cameras include a wide range of mounting systems including a shoe 40 formed on a myriad of mounting hardware and mounting systems. Some implementations of the present disclosure provide camera control system 1 which interferes with existing camera mounting hardware and systems to the minimum extent possible.

As described above, the camera control system 1 includes one or more camera control modules 42 each slidably disposed on the exterior surface 42 of the camera 2 and an electronic communication with a central hub 46 via a multiconductor camera control cable 47. As shown in the various drawings, the components of the camera control module 42 can be disposed within an outer shell 48 designed to slide easily yet snugly over the end 50 of the camera 2 opposite the lens 14 to about the battery compartment 24 and USB port 28 with the longitudinal internal edges 51 of the shell 46 effectively forming guiderails to receive the longitudinal external corners 52 of the camera 2, thereby assuring proper alignment of a USB plug 54 (as described in greater detail below) and shutter release mechanism 56 (as described in greater detail below) with the USB power and data port 28 and shutter button 20 respectively. A first opening 58 is formed in the rear face 60 of the shell 46 to allow the user to visually and mechanically access the rear display and control screen 62 of the camera 2 which functions both as a monitor and touch screen control of the camera 2. A second opening 64 is formed in the lower surface 66 of shell 46 to accommodate installation and removal of the various mounting brackets that may be used with the camera 2. A first recess 68 is formed in the inner front surface of the shell 46 over the front display screen 16 of the camera 2 to receive camera status sensors 70, a microcontroller 72, and other components described below. A second recess 74 is formed in the upper interior surface 76 of the shell 46 above the camera 2 shutter button 20 to receive to mechanical linkage between a servo 86 and the shutter button 20 as described in more detail below. The open end 80 of the shell 46 opposite the camera lens 14 is comprised of a removable panel 82. The removable panel 82 serves to enclose a first circuit board 84 upon which the servo 86, DC to DC power converter 88, USB power plug 54, cooling fan 90, and supporting circuitry are mounted as described in more detail below. An opening 92 is formed in the rear outer vertical surface of the control module shell 46 to receive the multi conductor cable connector 94, where it is held in place between the rear edge 96 of the shell 48 and the removable panel 82. The removable panel 82 may include one or more openings which function as air intake ports 98 and exhaust vents 100 to facilitate the operation of the cooling fan 90. Various indentations 102 are formed on the outer surfaces of shell 46 to facilitate the user's grip on the shell 46 when installing or removing the camera control module 42 from camera 2.

The working components of the camera control module 46 are grouped into four main assemblies including: a first assembly comprised of the multiconductor control cable 47; cable connector 94; a second assembly including a first printed circuit board 84 upon which is mounted the servo 86, DC to DC power converter 88 a third assembly including a second printed circuit board 106 upon which is mounted the camera status sensors 70 each including a phototransistor 108, the microcontroller 72 and supporting circuitry; and a fourth assembly comprising the shutter mechanism 56. It should be noted that the various components of each assembly could be formed directly in the wall of the shell 48, and that the election to include the various components on circuit boards and in groups as described as assemblies is made here to suggest one approach for the ease of construction and description, and not offered as a structural or functional limitation of the present disclosure.

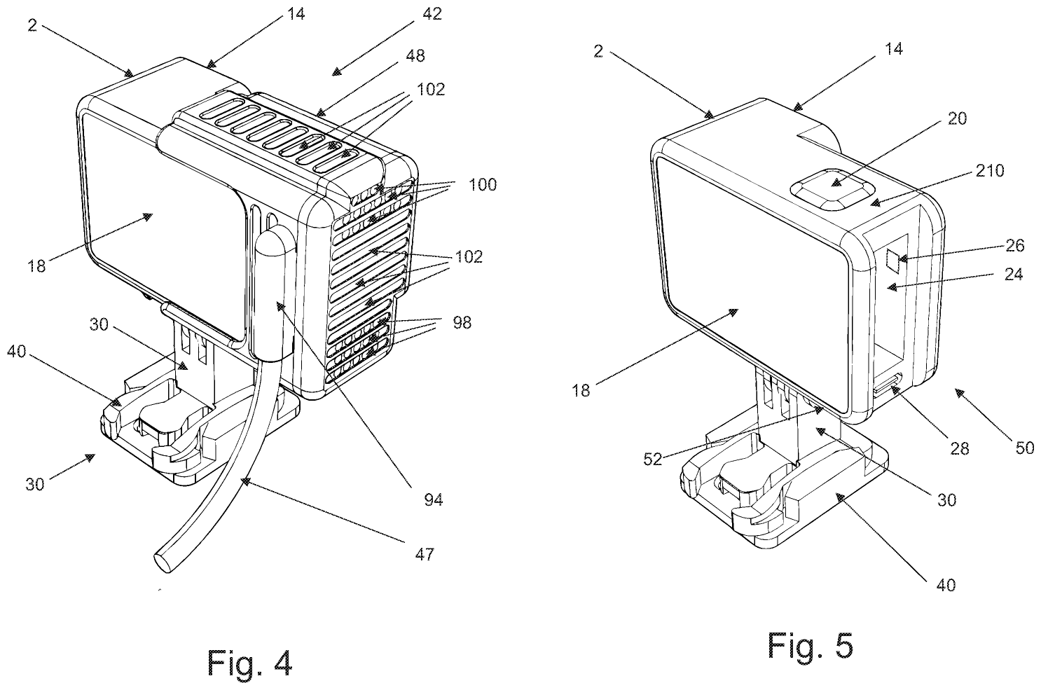

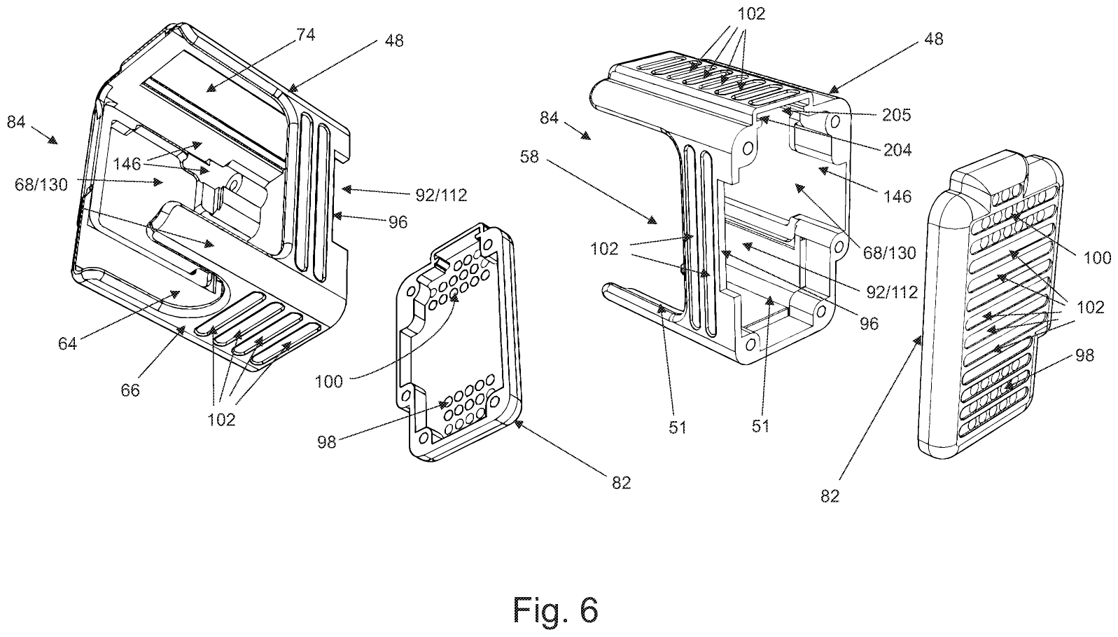

As depicted in FIGS. 4 and 6, the multiconductor control cable 47 is received by and mechanically affixed to the cable connector 94 which includes interlocking surfaces 110 received by the opening 112 formed between the end of the shell 46 and the removable panel 82 in order to transfer any mechanical stress from the multi conductor cable 47 to the shell 48 thus avoiding any damage to the various conductors in the multiconductor cable 47. The cable connector 46 includes gallery 114 for the passage of the various signal lines from the multi conductor cable 47 and the first printed circuit board 104.

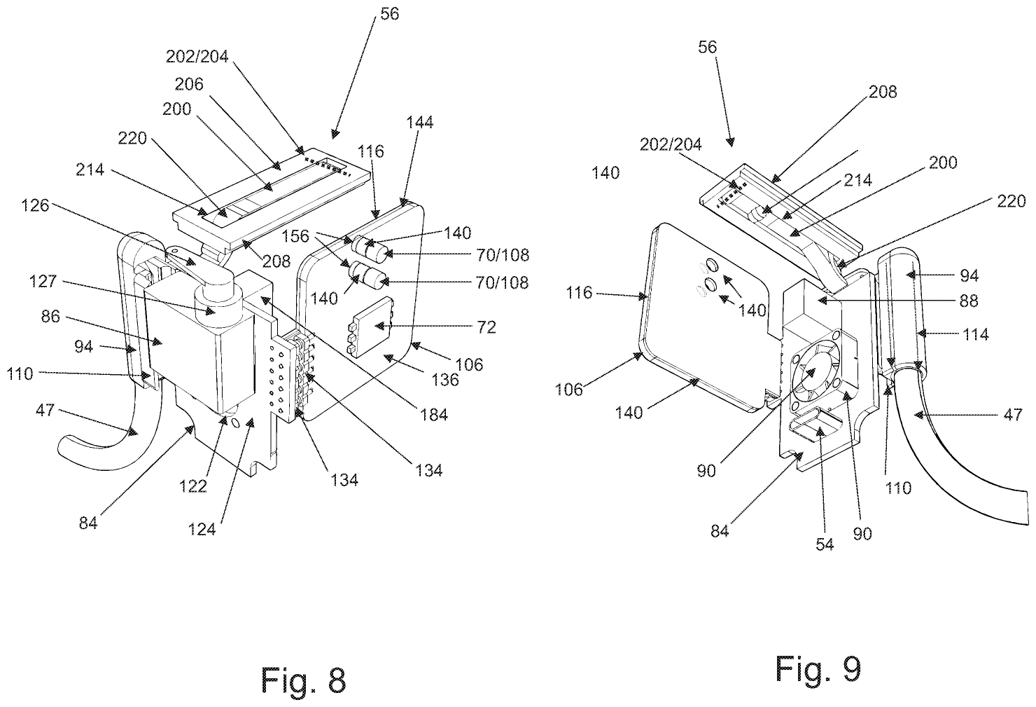

As shown in FIGS. 8-10, the second printed circuit board 106 of the second assembly is disposed in the interior end of the shell 46 parallel to the end of the camera 2 such that when the camera control module 48 is installed on the camera the interior surface 116 of the second printed circuit board 106 is in direct communication with the outer surface 118 of the camera 2 (through an opaque gasket 142 disposed between the inner surface of the second printed circuit board 106 as will be described in more detail below. A primary function of the first printed circuit board 104 is to provide electrical contact and communication between the multiconductor control cable 46, the servo 86, the cooling fan 90, and the second printed circuit board 106 of the second assembly. An additional function of the first printed circuit board 104 is to act as a structural element of shell 46 and to support each of the components. The USB power plug 54 is rigidly attached to the first printed circuit board 104 thereby holding it in alignment within the USB power port 28 of the camera 2 such that when the camera control module 42 is installed on the camera 2 the USB power plug 54 engages the USB port 28 on the camera 2. Similarly, the cooling fan 90 and DC to DC power converter 88 are attached to the interior surface 120 of the first printed circuit board 104 such that both are in alignment with the battery compartment 24 of the camera 2 and each may protrude into the interior of the battery compartment 24 when the camera 2 control module 42 is installed on the camera 2. An on opening 122 is formed through the first printed circuit board 104 to allow air to flow through intake ports 98 in the outer panel 82 and cooling fan 90 to the battery compartment 24. The servo 78 is rigidly affixed to the outer surface 124 of the first printed circuit board 104 such that a servo arm 126 or circular cam 128 mounted on the shaft 127 of the servo is in proper alignment with the shutter release mechanism 56 as described in greater detail below.

As best understood with reference to FIGS. 6 and 8, the second printed circuit board 104 of the third assembly is received by a recess 130 in the front wall 132 of the shell 46 directly over the front display screen 16 of the camera 2 when the shell 46 is installed on the camera 2. The second printed circuit board 106 is in electronic communication with the first printed circuit board 104 of the first assembly by means of wires and or pin and socket connectors 134 common in the art. The microcontroller 72 is mounted on the outer surface 136 of the second printed circuit board 106 in electronic communication with the various other components described. One or more photo transistors 108 or other optical sensors are mounted on the outer surface 136 of the second printed circuit board 106 of the third assembly in alignment with the indicator lights 6 and/or or with specific areas 138 of the front display screen 8. Apertures 140 are formed through the second printed circuit board 106 such that light emitted from the indicator lights 6 or specific areas 138 of the front display screen 8 can be received by the phototransistors 108. An opaque gasket 142 is formed on the inner surface 144 of the second printed circuit board 106 adjacent to the front display screen 5 of the camera 2. The opaque gasket 142 extends across the entire outer surface 136 of the second printed circuit board 106 and, if necessary, across parts of the front inner surface 146 of the shell 46 as may be necessary to cover the entire front display screen 8. The function of the opaque gasket 142 is to ensure that no light other than that generated by the indicator light 6 or specific areas 138 of the front display screen 8 can reach the phototransistors 108. In practice ambient light may penetrate shell 46 or the space between the outer surface 148 of the camera 2 or front display screen 8 and the inner surface 146 of the shell 48. The front display screen 8 includes an outer transparent panel 152 and an inner display panel 154 with there being some distance between the outer surface of the outer transparent panel 102 and the inner display panel 154. Ambient light reaching the periphery of the front display 8 may penetrate the outer transparent panel 152 and be reflected off the surface of the inner display panel 154 towards the phototransistors 108. Other illuminated areas of the inner display panel 154 near or adjacent to the specific areas 138 of the front display screen 8 upon which phototransistors 108 are focused may reach them. Apertures 156 formed in the opaque gasket 142 in alignment with apertures 140 formed in the second printed circuit board 106 and phototransistors 108 serve to further reduce the field of view available to the phototransistors 108. The opaque gasket 142 is typically constructed of felt or similar materials such that the gasket 142 can slide easily across the front display screen 8 of the camera 2 while remaining in substantial contact with the outer surface of the front display screen 8. Because of the compressibility of the fiber matt layer of felt or similar material the installation of the camera control module 42 on the camera 2 tends to compress the gasket 142 thereby making the gasket 142 even more resistant to the passage of unwanted light.

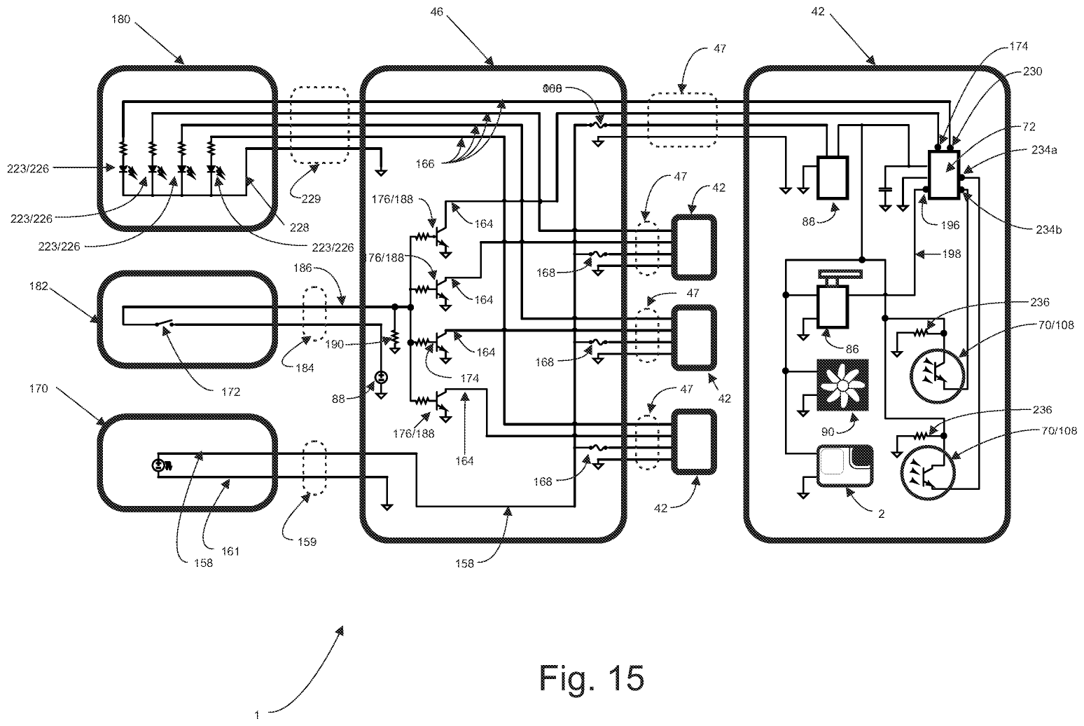

With reference to FIG. 15. It can be seen that the central hub 46 includes circuitry for high voltage conductors 158, shutter release signal lines 164, and camera status signal lines 166. A fuse 168 is provided in each high voltage conductor 158 between the power source module 170 and each camera control module 42. Where the cameras 2 and other components typically operate on 3 to 5 volts dc, the high voltage conductors 158 typically maintain a voltage of 12 v or greater to reduce voltage drop when the cameras 2 are located at greater distances from the central hub 46 so that the voltage lever at the DC-to-DC converters remains above the threshold input voltage for the converters. The shutter release signal lines 164 are selectively energized or connected to chassis ground by the user's manipulation the status of the shutter release switch 172. The logic level voltage state is then communicated to corresponding digital input pin 174 on the microcontroller 72 in each camera control module 42 via the shutter release signal line 164 in the multiconductor connection line connection cable 47 As will be described in greater detail below, the release signal passes through an isolation circuit 176 in the central hub 46 which prevents transient voltage fluctuations in the shutter release circuits in each camera control module 42 from electronically interfering with that of any of the others. The camera status signal lines 166 disposed within the multiconductor connecting cable 47 provide for the electronic connection between the camera status signal received from each camera control module 42 and a corresponding display lamp 178 or other device located in the camera status display module 180.

The power source module 170 can be any DC power generating device including a battery or electrical system of a vehicle. The power source module 170 typically supplies 12 volts of DC current although the high voltage conductors 158 the DC-to-DC power converters 88 in the central hub 46 and each camera control module 42, which are typically designed to accept a wide range of input voltages. Line conditioners or other devices may also be included in the power supply module or in the central hub in order to provide sufficiently clean power supply for the DC-to-DC converters 88 in the central hub 46 and the camera control modules 42. The power supply module 170 is connected to the central hub by a multiconductor cable 159 within which the high voltage conductor 158 and a chassis ground conductor 161 are disposed.

The shutter release switch 172 is comprised of a latching switch disposed within a switch console 182. It should be noted that a momentary switch may be substituted in place of shutter release switch 172, with the choice being relative to whether a still camera 2 function or video function is being controlled, as well as user preferences, but such choice is not intended as a limitation of the present disclosure. The shutter release switch 172 is connected to the shutter release signal line 164 in the central hub 46 by means of a multiconductor switch signal cable 184 including a logic level voltage supply line between the shutter release switch 172 and the DC-to-DC converter 88 in the central hub 46, and a voltage return line 186 between the shutter release switch 172 and the isolation circuits 176 in the central hub. Selective operation of the shutter release shutter release switch 172 opens or closes a circuit between the DC-to-DC power converter 88 in the central hub 46 and the base of one or more NPN bipolar transistors 188.

The emitter of each transistor 188 is connected to chassis ground while the collector of each transistor 188 is connected to a digital input pin 174 on the microcontroller 72 in the camera control module 42 via a shutter release signal line 164 in the multiconductor connection cable 47. When the shutter release switch 172 and related circuit is closed, logic level voltage is drained from the digital input pin 174 through the shutter release signal line 164 and transistor 188 to chassis base, resulting in a logic level of 0 on the digital input pin 174. When the shutter release switch 172 and related circuit is open no current is allowed to flow from the DC-to-DC converter 184 to the base of the transistor 188, any residual current on the line is drained to chassis ground through a pull-down resistor 190 with the result that the base of the transistor 188 is subjected to substantially zero voltage. As the voltage level present at the base of the transistor 190 approaches 0, current is no longer able to flow through it from the digital input pin 174 to chassis ground and internal pull up resistors on the microcontroller 72 cause the voltage present on the digital input pin 174 to a logic level high state. Algorithms implemented in the firmware of the microcontroller 72 continuously test the logic status of the digital input pin 174 and based on the result thereof control the servo 86 and servo arm 126 to rotate to either a first position 192 or a second position 194 via a pulse width modulated signal generated on a digital output pin 196 on the microcontroller 72 and transmitted to the servo 86 by a servo control signal line 198. As can be appreciated from the electrical schematic in FIG. 15 voltage is applied to each of the transistors 174 simultaneously such that the shutter release signal is received by the microcontroller in each camera control module 42 simultaneously. The algorithms implemented in the firmware of each microcontroller 72 are substantially similar as are the cameras 2, servos 86 and shutter mechanisms The shutter release functions in some or all of the camera control modules will occur substantially simultaneously.

As best shown in FIGS. 8-14, the shutter release mechanism 56 includes a linear actuator arm 200 disposed above and spanning across the shutter button 20 of the camera 2 and pivoting around an axel 202 formed in one end of the linear actuator arm 200. The axle 202 of the linear actuator arm 200 is received by a race 204 formed in a support frame 206. The outer longitudinal edges 208 of the support frame 206 are received by races 204 formed in the recessed area 205 of the shell 46 such that the linear actuator arm 200 and support frame 206 may be slidably installed in the shell 46 and then held in place by the removable panel 82. The linear actuator arm 200 can rotate upward and away from the upper surface 210 of the camera 2 and the shutter button 20 into a first position 212 inside a recess 214 formed in the support frame 206 thereby allowing the camera 2 to pass freely below the linear actuator arm 200 when the camera control module 42 is installed on the camera 2. A shutter button engagement surface 216 is formed on the lower surface 218 of the actuator arm 200 protruding towards the shutter button 20. A downwardly sloping cam surface 220 is formed on the end of the linear actuator arm 200 opposite the axel 202. An engagement arm 126 or circular cam 128 is rotatably disposed on shaft 127 of the servo 86 on an axis perpendicular to rotational plane of the linear actuator arm 200. When the servo shaft 127 is selectively rotated in one direction the outer edge 129 of the engagement arm 126 or cam 128 engages the cam surface 220 causing the linear actuator arm 200 to rotate from the first position 212 downward towards the upper surface 210 of the camera 2 to a second position 222 with the result that the shutter button engagement surface 216 depresses the shutter button 20, the opposite effect being achieved when the actuator 126 or cam 128 is rotated in the opposite direction.

The camera status display module 180 is comprised of one or more indicator lights 222, (there being one for each camera control module 42), the indicator lights 222 being disposed within a display console 224 and connected to the central hub 46 via camera status signal lines 166 disposed within the multiconductor control cable 47. In the preferred embodiment each indicator light 222 is comprised of a single light emitting diode 226 but it will be appreciated if any other type of light emitting device could be utilized. In addition to each of the camera status signal lines 166, a ground conductor 228 is provided to connect chassis ground in the display module to chassis ground in the central hub 46. Each of the camera 2 status signal lines 166 are routed through multiconductor cable 229 to the central hub 46 and multi conductor control cable 47 to the digital output pin 230 on the microcontroller 72 in each of the camera control modules 42. The digital output pin 230 and corresponding camera status signal line 166 or brought to a high or low logic state according to algorithms implemented in the microcontroller 72 firmware in response to the signals received from the one or more phototransistors 108 in optical communication with indicator lights 6 and or specific areas 138 of the front display screen 8. Each phototransistor 108 is focused on indicator light 6 or specific area 138 of front display screen 8 such that light emitted impinges on the base of the phototransistor 108. The collector of each phototransistor 108 is connected to the logic level voltage output of DC-to-DC power converter 88 and to chassis ground through a pull-down resistor 236. The emitter of each phototransistor 108 is connected to digital input pins 234a/234b on the microcontroller 72. When light impinges the base of the phototransistor 108, current is allowed to flow from the DC-to-DC power converter 88 through the phototransistor 108 to the digital input pins 234a/234b on the microcontroller 72 raising the voltage thereon and resulting in logic level state of 1 on the digital input pin 234a/234b. It is to be understood that one of the When no light impinges on the base of the phototransistor 108 insufficient current is allowed to travel from the DC-to-DC power converter 88 through the phototransistor 108 to the digital input pins 234a/234b. The logic state of the digital input pins 234a/234b are repeatedly polled by algorithms implemented in the firmware of the microcontroller 72 interpret result value of the camera 2 parameter that the illumination state of the indicator light 6 or the specific area 138 of the front display screen 8 is meant to convey to a human observer. For example, on the GoPro Hero Nine camera 2, the specific area 138 on the front display screen 8 is illuminated when the camera 2 is recording a video, and dark when the camera 2 is not recording a video. When the specific area 138 is illuminated resulting in a logic state of 1 on the digital input pins 234a/234b, algorithms may execute subroutines appropriate when the camera 2 is recording. For instance, a particular subroutine may change the logic level voltage of the digital output pin 230 to high thereby energizing the indicator light 222 on the monitor module 180. It should be noted that various algorithms implemented in the firmware of each microcontroller 72 may also provide the ability to the modulate sequence, duration, and intervals of both the servo shaft 127 movements as well as the logic level voltage states of the camera status signal lines 166 independently from the sequence, duration, and intervals of shutter release signal and the camera status sensor values. Similarly, algorithms implemented in the firmware of the microcontroller 72 can also allow for the shutter mechanism operations and camera status monitoring operations to take place independently of one another, enter-dependently of one another, or some combination thereof. By way of example, firmware algorithms may be designed such that the engagement of the shutter release mechanism with the shutter button 20 simply mimics the position of the shutter release switch 172, that is when the shutter release switch 172 is toggled to a first position the shutter button 20 is depressed, and when the shutter release switch 172 is toggled to a second position the shutter button 20 is released. Alternatively, algorithms can be implemented with the effect that when the shutter release switch is toggled to a first position the shutter button 20 is depressed for a predetermined period of time and then disengaged, and when the shutter release switch is toggled to the second position the shutter button 20 is again depressed for a predetermined period of time and then released. In yet another example, it can be arranged such that when the shutter release switch 172 is toggle to the first position the shutter button 20 on the camera 2 is depressed until such time as the microcontroller 72 detects that a light or area of a screen on the camera 2 has become illuminated thus indicating that recording has begun upon which the shutter button 20 is then released. Conversely, when the shutter release switch is toggled to the second position the shutter button 20 is depressed until such time as the microcontroller 72 detects that the indicator light 6 or specific area 138 of the front display screen 8 is no longer illuminated indicating that recording has ceased the shutter button 20 is released. Similar effects can be achieved through algorithms in the microcontroller 72 firmware with regards to the camera status monitoring function. For example, algorithms may be implemented such that when an indicator light 6 or specific area of the front display screen 138 is illuminated a corresponding indicator light 222 on the status monitoring module 180 is also illuminated, and vice versa. In a second example, algorithms could be implemented such that in the event that the shutter release switch 20 is in a position indicating that the user intends that the camera 2 be in active recording mode but where the corresponding indicator light 6 indicator or specific area 138 of the front display screen 8 is not illuminated, the corresponding light on the status monitoring module could be caused to flash in order to alert the user that a malfunction of one kind or another has occurred.

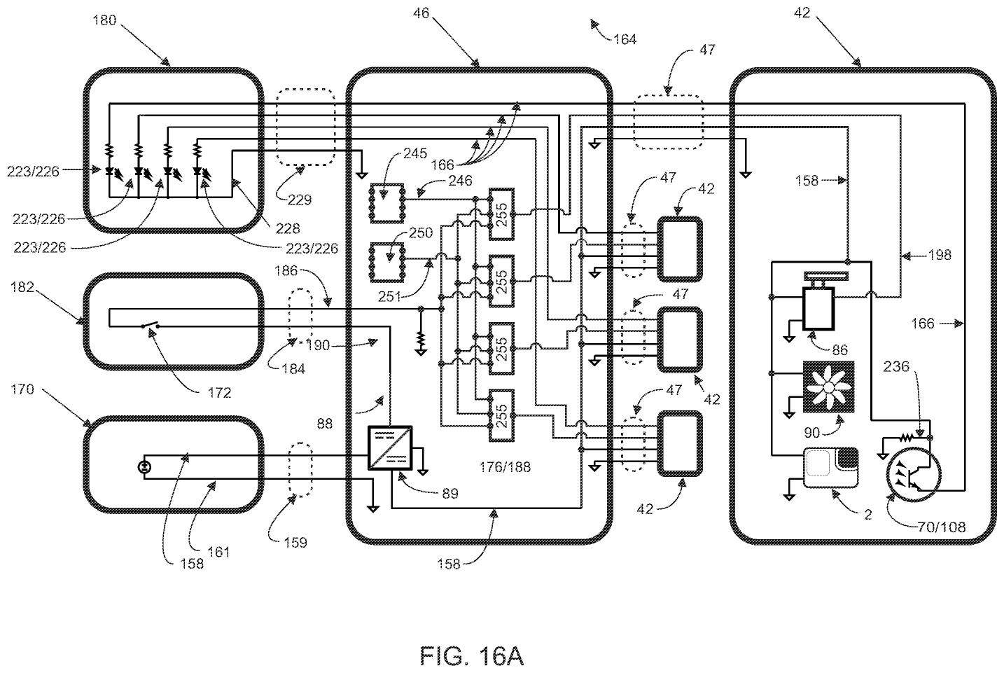

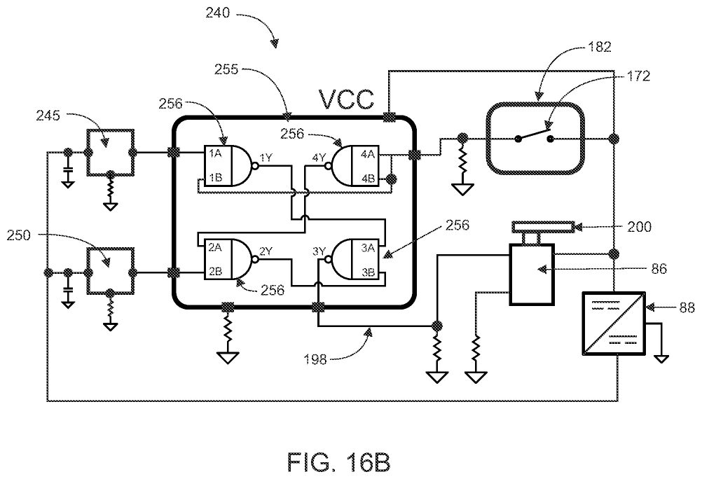

FIGS. 16A and 16B depicts alternative embodiments of the present disclosure appropriate for applications where the cameras 2 are located close enough to the central hub 46 that multiconductor camera control cable 47 is short enough to avoid deleterious effects of voltage drop on power levels and signal integrity. A typical, but not exclusive application for this embodiment would involve the central hub 46 as and the cameras 2 clustered together on or inside a single common camera mount or device. In this embodiment the DC-to-DC power converter 88 is deleted from the camera control module 42 altogether, with some or all components being powered by a larger DC-to-DC power converter 89 in central hub 46. Likewise, microcontroller 72 are also deleted altogether from the camera control module 42, with servo 86 receiving control signals from a central servo control circuit 240 in the central hub 46 and the photoresistor 70/108 in direct electrical communication with a corresponding indicator light 222 via a camera status signal line 166 routed through the multiconductor camera control cable 47, central hub 46, and multiconductor cable 229.

As best understood with reference to FIG. 16A, the central servo control circuit 240 is comprised of a first signal generator 245, a second signal generator 250, and a logic module 255 for each camera control module 42 in the system. The first signal generator 245, typically comprising a small microcontroller, continuously generates a pulse width modulated signal which, when communicated to servo 86 results in servo shaft 127 being selectively rotated such that the outer edge 129 of the engagement arm 126 or cam 128 engages the cam surface 220 causing the linear actuator arm 200 to rotate from the first position 212 downward towards the upper surface 210 of the camera 2. The first signal generator 245, typically comprising a small microcontroller, continuously generates a pulse width modulated signal which, when communicated to the servo 86 results in the exact opposite direction effect. Each logic module 255 is comprised of four NAND logic gates 256 arranged in a shown in FIG. 6. As further shown in FIGS. 16 and 16a the signal outputs of the first signal generator 245 and second signal generator 250 are connected to corresponding input pins on each logic module 255 via common signal lines 246 and 251 respectively, as is the voltage return line 186 from the switch 172. As a result of the combined logic of the NAND gates in logic module 255, When switch 172 is closed, the control signal generated by the first signal generator 245 is transmitted by each logic module 255 over servo control signal line 198 to its corresponding servo 86. Similarly, when switch 172 is open, the control signal generated by the first signal generator 250 is transmitted by each logic module 255 over servo control signal line 198 to its corresponding servo 86. The as will be apparent to those skilled in the art, the central servo control circuit 240 performs three key functions which are necessary for the substantially simultaneous action of the servos attached to the system including the providing substantially similar control signals to some or all servos, filtering or line conditioning, and signal voltage buffering.

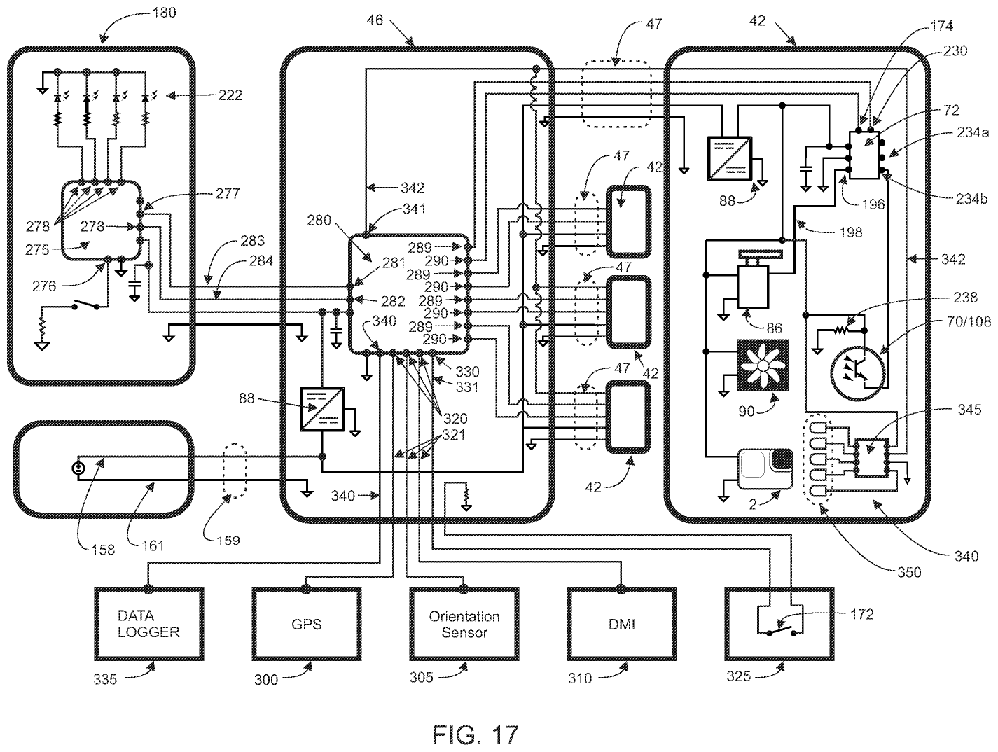

FIG. 17 depicts yet another embodiment of the present disclosure where the most distinctive change is the addition of a command-and-control microcontroller 275 in the control console in two-way serial communication with a system management microcontroller 280 in the central hub 46. A digital input pin with pullup resistors 276 is connected to the common pole of switch 172, and the normally open pole of switch 172 is connected to chassis ground such that when switch 172 is opened or closed pin 276 will register a logic state of 0 or 1 respectively. Similarly, a plurality of indicator lights 222 on the control console 180 are each connected to a digital output pin 278 on the command-and-control microcontroller 275 such that each indicator light 222 may be lit or extinguished by programmatically setting the logic state of its corresponding digital input pin to 1 or 0 respectively. UART transmitting pin 277 and UART receiving pin 278 on the command-and-control microcontroller 275 are maintained in asynchronous serial communication with UART receiving pin 281 and UART transmitting pin 282 on system management microcontroller 280 via serial signal line 283 and serial signal line 284 respectively.

Firmware in the command and control microcontroller 275 continuously polls the digital input pin 276 and upon each iteration, transmits a command byte corresponding to the value of the currently logic state of the pin 276 The system management microcontroller 280 includes a plurality of digital input pins 289 with pull up resistors with each being connected to digital output pin 230 on the microcontroller 72 in each of the camera control modules 42 via a camera status signal line 166 such that the logic state of the digital input pin 289 mirrors the substantially real-time logic state of digital output pin 230. Similarly, the system management microcontroller 280 include a plurality of digital output pins 290 with each being connected to a digital input pin 174 on the microcontroller 72 in each of the camera control modules 42 via a camera status signal line 164 such that the logic state of the digital input pin 174 mirrors the substantially real-time logic state of digital output pin 290.

In the most basic operational embodiment, the command-and-control microcontroller 180 and the system management microcontroller 280 continuously poll their respective digital input pins and incoming messages from the other, and then change the state of their respective digital output pins and transmit data to the other accordingly. Firmware in the command and control microcontroller 275 repeatedly polls the logic state of digital input in 276 and transmits the binary equivalent of that state to the system management microcontroller 280 in the form of a single command byte where the least significant bit (LSB) is set to 1 or 0. Upon receipt of the byte by the system management microcontroller 280, the command bit (LSB) is extracted from the received byte using bit masking, a bitwise operation, or LSB extraction, and the resulting LSB value is subsequently used to set the logic state of the digital output pins 290. Likewise, firmware in the system management microcontroller 280 repeatedly polls the logic state of each digital input pin 289 and (up to a total of eight), with each pin's logic state assigned to a status bit within a single status byte, starting with the LSB. These command bits are then transmitted to the command-and-control microcontroller 175 as a single status byte. Upon receipt of the status byte by the command-and-control microcontroller 275, the status bit for each corresponding camera is extracted from the received status byte using bit masking, a bitwise operation, and the resulting bit value is subsequently used to set the logic state of each digital output pin 278.

While the embodiment described above includes a single switch 172 functionally coupled to the shutter button(s) 20 in order to effect common and substantially simultaneous operation of some or all cameras 2 attached to the system, it should be appreciated that independent operation of each camera could be provided for in the same manner in which the multiple indicator lights 222 are independently controlled via single status byte transmitted from the system management micron controller. For example, a switch 172 could be provided for each camera 2, with each switch 172 being connected to a corresponding digital input pin 276. The firmware in the command and control microcontroller 275 would then combine the logic values of each digital input pin separate command bits into a single command byte to be transmitted to the system management microcontroller 280 in the same manner in which the system management microcontroller 280 derives and transmits a single status byte containing status bits based upon the logic state of the digital input pins 289. Upon receipt of the command byte by system management microcontroller 280, each command bit would be extracted and used to assign the logic states of the digital output pin(s) 290 thereby affecting independent control of the servo 86 in each camera control module 42.

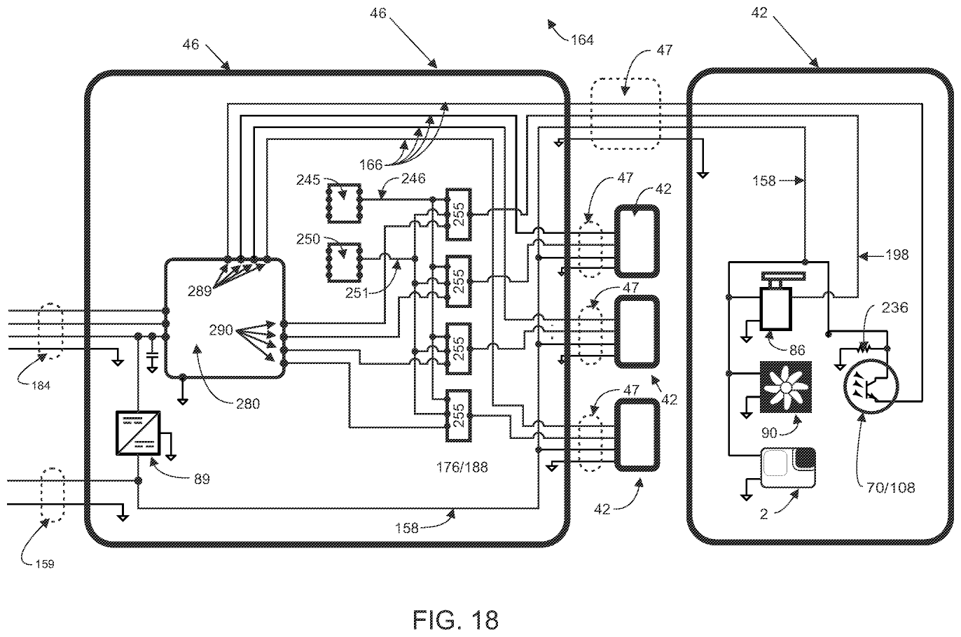

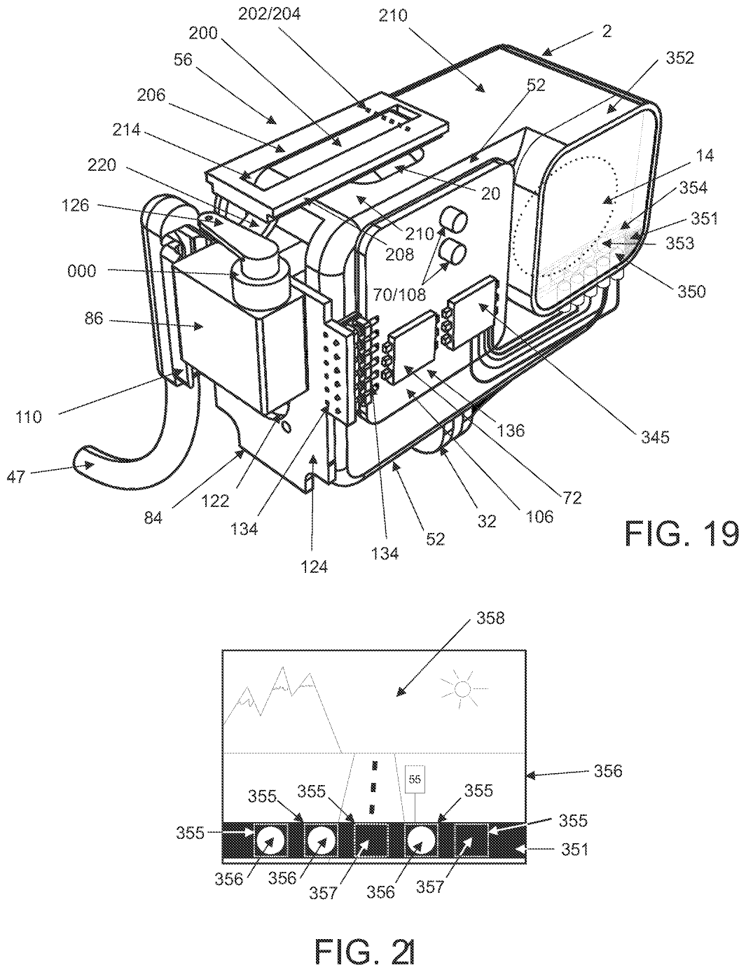

With reference to FIG. 18 yet another embodiment of the present disclosure is disclosed which demonstrates the adaptation of the command-and-control microcontroller 275 system management microcontroller 280 combination design depicted in FIG. 17 with central servo control circuit 240 depicted in FIGS. 16A and 16B. In this embodiment the digital output pins 290 are each connected to a logic module 255 rather than the digital input pin digital input pin 174 on the microcontroller 72b, and digital input pin(s) 289 are connected to directly to a corresponding camera status sensor 70 rather than a digital output pin on 230 on a corresponding microcontroller 72.

As described thus far the switch 172 and indicator lights 222 on the control console 180 are rendered the functional equivalents of the of the shutter button 20 and record indicator lamps 6 or specific areas of the screen 138 on the camera 2 respectively. More specifically, if switch 172 is closed the shutter button 000 is depressed and if the switch 172 is opened the shutter button 20 is released. Similarly, the illumination state of the recording indicator 6 lamp or screen area 138 is mirrored by the illumination state of the corresponding indicator lamp 222 on the control console. While this functional relationship does provide for a very simple and intuitive operation of multiple cameras, it introduces certain inefficiencies and inconveniences as well. For example, when the switch 172 is closed, there will necessarily be some delay in the start of recording and thus in the illumination of the indicator light 222 and feedback to the user as well. In the event a particular camera stops recording prematurely or begins recording erroneously, the unwanted condition might go undetected unless the user notices the differences in the illumination states of the indicator lights. With the introduction of the command-and-control microcontroller 275 and system management microcontroller 280 however, both the switch 172 and indicator lights 222 can be decoupled from their functional equivalents on the camera to provide expanded convenience and capabilities in the operation of the system. For example, when some or all cameras are intentionally at rest and not recording, no indicator light would be illuminated. Upon the intentional start of recording a steady state illumination would be immediately implemented and maintained to reassure the user that recording has commenced and continues. Where recording unintentionally stops or starts a persistent flash pattern would be maintained to alert the user of the unexpected or unwanted condition.

The system management microcontroller 280 may be connected to communicate with a plurality of external devices producing metadata such as camera location and orientation, distance traveled, user flags and the like which can saved to a common time-indexed file and later correlated to individual images or video frames. In the embodiment depicted in FIGS. 17-19, a GPS receiver 300, camera orientation sensor 305, and a distance measuring device (DMI) 310 are maintained in serial communication via serial signal lines 301 with UART receiving ports 320 on the system management microcontroller 280 whole a user flag device 325 is connected to a digital input pin with pullup resistors 330 via a digital signal line 331. As will be discussed in greater detail below, the system management microcontroller 280 continuously receives and time stamps incoming metadata these devices, together with a time stamped record of any signal to the frame-marking device or change in camera control or status bytes and transmits the resulting records to a data logger 335 via UART transmitting pin 340 and serial signal line 341 in a common time-indexed meta data file. The user flag device 325 allows a user to note the existence presence of a significant event, condition or object opening or closing a switch with the result that the status of the switch will be recorded in time stamped records in the time-indexed metadata file for later correlation with individual video frames.

The system management microcontroller 280 is in further digital communication with a video frame-marking device 340 located in each camera control module via a digital output pin 341 and digital signal line 342. As further illustrated in FIG. 19, the video frame-marking device 340 consists of a microcontroller 345 in connected to the system management microcontroller 280 vis digital signal line(s) 342 and a digital input pin with pull up resistors 343. Microcontroller 345 is further connected to a plurality of led lamps 350 disposed within a lens cover 352 such that they are effectively mounted in front of and view of the camera lens 14 thereby forming a plurality of sub zones 355 within the frame image 356 which every in luminance and or color based upon the state led lamp in that zone. Further, the led lamps 350 may be different colors to increase the contrast between them. The lens cover 352 includes a dark backdrop 351 and foreground 354 around the led lamps 350 with apertures 353 to formed there in to expose the led lamps 350 to the camera sensor in order to enhance the contrast between illuminated sub zones 356, non-illuminated sub zones 357 and the image 358. The lens covers 352, led lamps 350, foreground 354 and background backdrop 351 may all extend farther out from the lens as required to produce sharp visual edge between the backdrop 351 and image 358, and to keep the sub zones 355 in focus, with the lens cover effectively comprising a lens hood. In operation, the system management microcontroller 280 periodically signals the frame-marking microcontroller bringing its digital input pin 341 low. Upon this signal the frame-marking microcontroller 345 initiates a binary counter which increments every millisecond, with its maximum limit slightly above the video's frame rate. The counter's value is written into the corresponding output pins of the led lamp 350 resulting in a visual representation of the counter across the subzones with each sub zone representing a binary digit where lack of illumination or a given color in a sub zone represents a 0 and the presence of illumination or a given color represents a 1. Because the counter only runs once for total duration roughly equivalent to a single frame, the counter display will only be visible in one frame for each frame marking signal transmitted by the system management microcontroller. As a result of the counter incrementing every millisecond, or roughly the same amount of time during which a frame image is actually recorded, only a single visual representation of the counter will be visible on the frame. Thus, by adding the counter value in milliseconds indicated by the sub zones of the frame to the system time at which the frame-marking signal was sent, a normalized system time forth video frame cane be calculated and correlated to the system times of the metadata received from other devices.

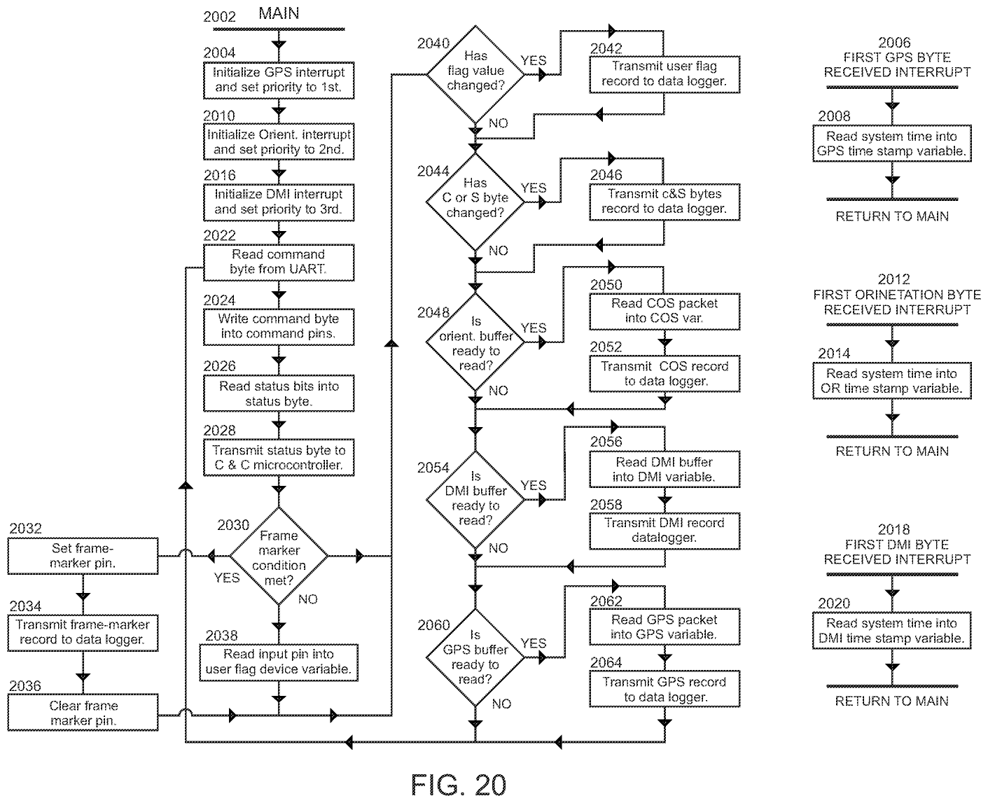

The operation of the system can best be understood with reference to FIG. 20 which is a flow chart describing example processes executed by the algorithms embodied in the system management microcontroller firmware. As shown in FIG. 20, processing begins at 2002, where the main firmware is run upon bootup. Processing continues to 2004.

At 2004, an interrupt is configured to activate upon receiving the initial byte of a data packet containing a NMEA sentence from GPS Receiver 300 (the GPS interrupt). The GPS interrupt is assigned the highest priority level, designated as ‘1’.

Activation of the GPS begins at 2006 upon receipt the first byte of a data packet from the GPS receiver 300. Processing then continues to 2008.

At 2008, the current system time is read into a variable associate with the arriving GPS data packet (The GPS time stamp). Processing then returns to the position in the main program when interrupted by the GPS interrupt. After the GPS interrupt has been initialized, processing continues to 2010.

At 2010, an interrupt (the COS interrupt) is configured to activate upon receiving the initial byte of a data packet containing a from the camera orientation sensor 305 (the COS). The COS interrupt is assigned the next highest priority level, designated as ‘2’. Activation of the COS interrupt begins at 2006 upon receipt of the first byte of a data packet from the camera orientation receiver 305. Processing then continues to 2008.

At 2008, the current system time is read into a variable associate with the arriving COS data packet (The COS time stamp). Processing then returns to the position in the main program when interrupted by the COS interrupt. After the COS interrupt has been initialized, processing continues to 2016.

At 2016, an interrupt (the DMI interrupt) is configured to activate upon receiving the initial byte of a data packet containing a from the distance measuring device (DMI) 310. The DMI interrupt is assigned the next highest priority level, designated as ‘3’. Activation of the DMI interrupt begins at 2018 upon receipt of the first byte of a data packet from the DMI 305. Processing then continues to 2020.

At 2020, the current system time is read into a variable associate with the arriving COS data packet (The COS time stamp). Processing then returns to the position in the main program when interrupted by the COS interrupt. After the COS interrupt has been initialized, processing continues to 2022.

At 2022, the command byte is read from the UART receiving pin 281. Processing continues to 2024.

At 2024, the bits from the command byte are read into the digital output servo command pins 290 for each camera module 42 connected to the system. Processing continues to 2026.

At 2026, the camera recording status byte is read from the digital input pins 289 which mirror the status of the recording indicator lights 6 or specific areas 138 of the front display screen 8 on each camera 2 respectively. Processing continues to 2028.

At 2028, the camera recording byte is transmitted to command-and-control microcontroller 275 via the UART transmitting pin 282. Processing continues to 2030.

At 2030, a sufficient amount of time has elapsed since the frame-marker device 340 was last triggered, processing continues at 2032.

At 2032, the fame-marker device is trigger by setting the digital output pin 341 is set to HIGH. Processing continues to 2034.

At 2034, a record is transmitted to the datalogger 335 including fields for the current system time and frame-marking trigger event label. Processing continues to 2036.

At 2036, the fame-marker device is trigger by setting the digital output pin 341 is set to HIGH. Processing continues to 2040. If at 2030, a frame-marker device trigger event is not initiated, processing continues to 2038.

At 2038, The status of the user flag device 325 is read from the digital input pin 330. Processing continues to 2040.

At 2040, if the value of the status of the user flag device as reflected by the logic state of digital input pin 330 has changed, processing continues to 2042.

At 2042, a record is transmitted to the datalogger 335 with fields containing the current system time, a user flag device label, and the current value of digital input pin 330. Processing continues to 2044. If at 2040, the status of the user flag device 335 has not changed, processing continues to 2044.

At 2044, if the value of the current command byte and or the current value of the status byte has changed, processing continues to 2046.

At 2046, a record is transmitted to the datalogger 335 with fields containing the current system time, a command and status byte label, and the current values of the current command byte and current status byte. Processing continues to 2048. If at 2044, The status of the user flag device 335 has not changed, processing continues to 2048.

If at 2048, a complete data packer from the COS is ready to be read, processing continues to 2050.

At 2050, a complete COS data packet is read from the UART buffer into a variable. Processing continues to 2052.

At 2052, a record is transmitted to the datalogger 335 with fields containing the COS time stamp, a COS label, and the contents of the COS data packet. Processing continues to 2054. If at 2048, a complete data packer from the COS is not ready to be read, processing continues to 2054. If at 2054, a complete data packer from the DMI is ready to be read, Processing continues to 2056.

At 2056, a complete DMI data packet is read from the UART buffer into a variable. Processing continues to 2060.

At 2060, a record is transmitted to the datalogger 335 with fields containing the DMI time stamp, a DMI label, and the contents of the DMI data packet. Processing continues to 2060. If at 2054, a complete data packer from the DMI is ready to not be read, processing continues to 2060. If at 2060, a complete data packet from the GPS is ready to be read, Processing continues to 2062.

At 2062, a complete GPS data packet is read from the UART buffer into a variable. Processing continues to 2064.

At 2064, a record is transmitted to the datalogger 335 with fields containing the GPS time stamp, a GPS label, and the contents of the GPS data packet. Processing continues to 2022. If at 2060, a complete data packet from the GPS is not ready to be read. Processing continues to 2022 where the process repeats until the system management microcontroller is powered down.

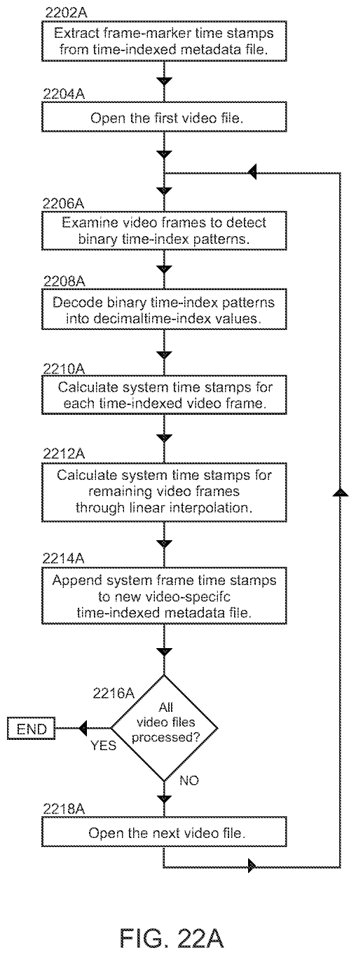

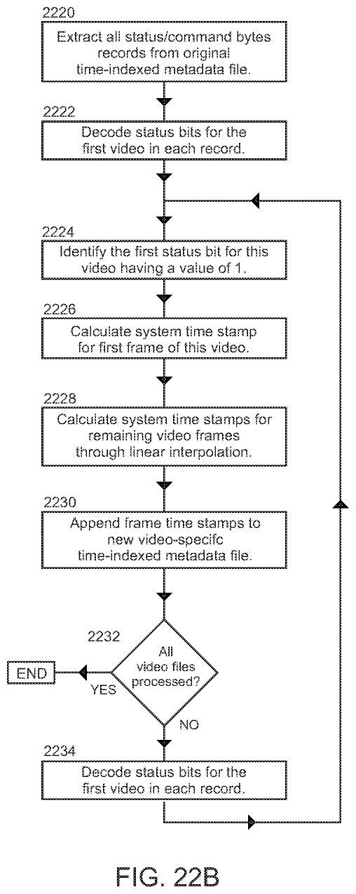

After a group of simultaneous video files have been recorded, each video file may be processed in combination with the time-indexed metadata file to create a video specific metadata file with interpolated metadata value for each frame of the video. The first step in this process is to create a system time stamp for each frame of the video and append it to a new video specific version of the time indexed metadata file retrieved from the data logger 335, the preferred method for which is best understood with reference FIG. 22A. Processing begins at 2202 where frame-marker device trigger records are extracted from the time-indexed metadata file. Processing continues at 2204.

At 2024, first video file is opened in preparation for examining the frame images 356 in the file. Processing continues to 2206.

At 2206, each frame image 356 is evaluated for the presence of binary time-index patterns in the sub zones 355 resulting from a frame-marking device event. Detection of the illumination and or colors 356 in the sub zones 355 is accomplished with software libraries well known in the art such as OpenCV or Tensorflow. In practice, only limited groups of frame images consistent with the intervals between frame-marking events need be evaluated. Processing continues to 2208.

At 2208, each binary time index pattern detected is decoded into a decimal time-index value. Processing continues to 2210.

At 2210, a system time stamp is calculated for the corresponding frame of each binary time index pattern detected. The system time stamp value is calculated by adding the decimal time-index value in milliseconds to the corresponding frame-marker device trigger record extracted from time-indexed metadata file at 2202. Processing continues to 2212.

At 2212, system time stamps are calculated for some or all remaining video frames by linear interpolation between time values of time stamps created at 2210. Processing continues at 2214.

At 2214, records for each video frame include fields for the time stamp value, a video frame label, and the video frame number are appended to a new video specific copy of the original time-indexed metadata file. Processing continues to 2216. If at 2216, a new video specific copy of the original time-indexed metadata file has been created for each video file in the group of simultaneously recorded video files, processing ends. If at 2216, a new video specific copy of the original time-indexed metadata file has not been created for each video file in the group of simultaneously recorded video files, processing continues at 2218.

At 2218, the next video file is opened in preparation for examining each frame image 356 in the file.

An alternative process for creating a system time stamp for each frame of the video is set forth in FIG. 22B. While this alternative is less typically less accurate than the process set forth in FIG. 22A, it can be useful in applications where a frame-marking device 340 is not present or malfunctions. Returning to FIG. 22B, processing begins at 2220, where some or all command/status byte records are extracted from the time-indexed metadata file retrieved from the datalogger 340. Processing continues to 2222.

At 2222, the status bits for the first video file are decoded from each status byte. Processing continues to 2224.

At 2224, successive status bits for the present camera are compared to find the first status bit with a value of 1, which indicates that the status of the recording indicator lights 6 or specific areas 138 of the front display screen 8 the camera had indicated the start of recording. Processing continues to 2226.

At 2226, the system time stamp for the first frame of the video is calculated by subtracting a temporal correction factor from the time value for the first statues bit having a value of 1. The temporal correction factor is the estimated delay between the actual system time at which the first video frame was recorded and the time the status byte record was created in the time indexed metadata file. The temporal correction factor would typically be derived from testing each camera with methods such as recording a mirrored image of the camera itself and counting the number of frames until the recording indicator appears. The factor could also be determined more accurately through comparison of the first appearance in time of the status bit equaling 1 with time stamps derived from the image marking process described in FIG. 22A. Processing continues to 2228.

At 2228, time stamp records are created for each successive frame in the video file by adding the frame duration, calculated as 1 divided by the frame rate, the time stamp value of the preceding record. Processing continues to 2230.

At 2230, records for each video frame include fields for the time stamp value, a video frame label, and the video frame number are appended to a new video specific copy of the original time-indexed metadata file. Processing continues to 2232. If at 2232, a new video specific copy of the original time-indexed metadata file has been created for each video file in the group of simultaneously recorded video files, processing ends. If at 2232, a new video specific copy of the original time-indexed metadata file has not been created for each video file in the group of simultaneously recorded video files, processing continues at 2234.

At 2234, the status bits for the next video file are decoded from each status byte. Processing continues to 2224.

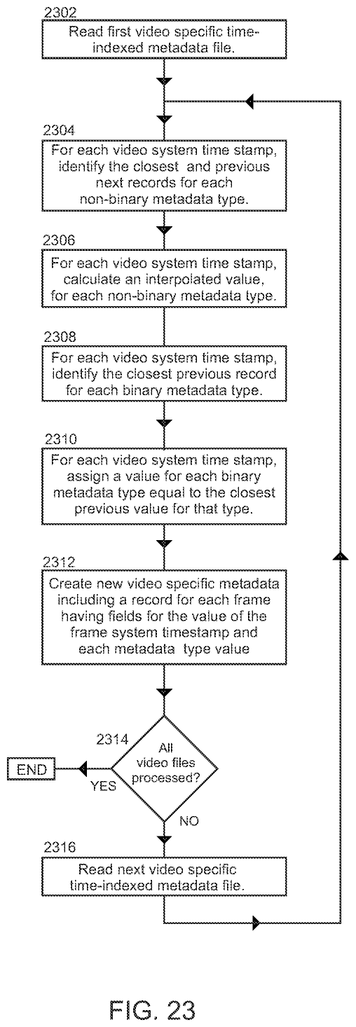

Once a video specific time-indexed metadata file has been created for each video, a frame specific metadata file is created for each video file including a record for each video frame having fields containing a frame number, a system time stamp, and frame specific values for each metadata type present in the original time-indexed metadata file. Where the frame system time stamps were derived from frame-marking metadata as described in FIG. 22A, the metadata records may be specific frame image as well as the frame itself. As shown in FIG. 23, processing begins at 2302 where the video specific time-indexed metadata file for the first video is opened and some or all records are sorted by time stamp value. Processing continues to 2304.

At 2304, for each video frame time stamp record the, the temporally closest previous and next GPS, COS, and DMI metadata records are identified. Processing continues to 2306.

At 2306, and GPS, COS, and DMI metadata values are calculated for each video frame through interpolation based on their relative system times. As will be appreciated by those skilled in the art, the processes described at 2304 and 2306 may be merged depending upon the algorithm and software used to accomplish the task. Processing continues to 2308.

At 2308, determine the temporally closest values for each binary number metadata such as command bits, status bits, and user flag status. Processing continues to 2310.

At 2310, assign a value for binary number metadata values to each vide frame record such as command bits, status bits, and user flag status value based upon the temporally closest value for that type. Processing continues to 2312.

At 2312, a new video frame-indexed metadata file is created including a record for each frame in the present video having fields for the value of the system time stamp, the frame number, and the value of each metadata type present in the original time-indexed metadata data file. Processing continues to 2314. If at 2314 frame specific metadata files have not been created for each video file, processing continues at 2316.

At 2314, the video specific time-indexed metadata file is read into memory. Processing continues at 2304. If at 2314 frame specific metadata files have been created for each video file, processing ends.

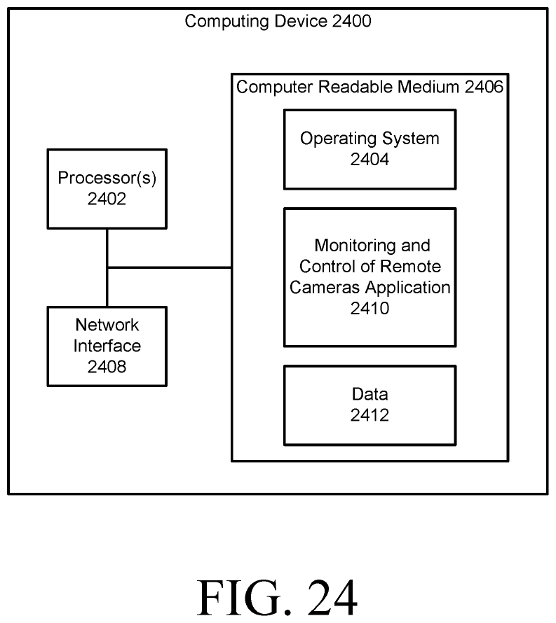

FIG. 24 is a diagram of an example computing device 2400 in accordance with at least one implementation. The computing device 2400 includes one or more processors 2402, nontransitory computer readable medium 2406 and network interface 2408. The computer readable medium 2406 can include an operating system 2404, an application 2410 for monitoring and control of multiple remote cameras and a data section 2412 (e.g., metadata as described herein, video files, etc.).

In operation, the processor 2402 may execute the application 2410 stored in the computer readable medium 2406. The application 2410 can include software instructions that, when executed by the processor, cause the processor to perform operations to control monitoring and control of multiple remote cameras in accordance with the present disclosure (e.g., performing associated functions described above).

The application program 2410 can operate in conjunction with the data section 2412 and the operating system 2404.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C #.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media to monitor and control multiple remote cameras.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A system comprising:
one or more camera modules;
one or more camera control modules, each corresponding to one of the one or more camera modules, wherein each camera control module is configured to actuate a corresponding one of the one or more cameras and monitor a status of that camera;
a user console including a camera shutter release control and a camera status indicator
a central control hub coupled to the user console and the one or more camera control modules, the central control hub configured to:
receive an electronic shutter control signal from the camera shutter release and physically activate or deactivate the one or more cameras, via the corresponding one or more camera control modules;
receive a physical status signal from each of the one or more cameras via the corresponding one or more camera control modules;
transmit an electronic indicator signal based on the physical status signal to the user console to cause the camera status indicator to represent a state of each of the one or more cameras as recording or not recording; and
a power supply circuit configured to supply power to the one or more cameras, the one or more camera control modules, the user console, and the central control hub,
wherein, when activated, the one or more cameras capture image data, and when deactivated the one or more cameras stop capturing image data.
